(19) United States
(12) Patent Application Publication
(10) Pub. No.: US 2021/0362710 A1
(43) Pub. Date: Nov. 25, 2021

(54) TRAVELING SYSTEM AND VEHICLE

(71) Applicant: LG ELECTRONICS INC., Seoul (KR)

(72) Inventors: Heedong CHOI, Seoul (KR); Gipoong GWON, Seoul (KR); Soojung JEON, Seoul (KR)

(73) Assignee: LG ELECTRONICS INC., Seoul (KR)

(21) Appl. No.: 16/500,799

(22) PCT Filed: Nov. 2, 2017
(86) PCT No.: PCT/KR2017/012297

§ 371 Date: Oct. 3, 2019

(51) Int. Cl. B60W 30/10; B60W 30/18; B60W 40/06; G05D 1/02

(52) U.S. Cl. CPC B60W 30/10; B60W 30/18; B60W 2420/42; G05D 1/021; G05D 2201/0213; B60W 40/06

(57) ABSTRACT

Disclosed is a traveling system including an object detection device including at least one sensor and a processor configured to acquire road situation information, to determine an expected traveling trajectory of a vehicle based on information about the field of view of the sensor and the road situation information, and to provide a signal for controlling at least one of steering, braking, or acceleration based on the expected traveling trajectory.

### TECHNICAL FIELD

The present invention relates to a traveling system and a vehicle.

### BACKGROUND ART

A vehicle is an apparatus that moves a passenger in a direction in which the passenger wishes to go. A representative example of the vehicle is a car.

Meanwhile, a vehicle has been equipped with various sensors and electronic devices for convenience of users who use the vehicle. In particular, research on an advanced driver assistance system (ADAS) has been actively conducted for convenience in driving of the user. Furthermore, an autonomous vehicle has been actively developed.

In order to realize the advanced driver assistance system and the autonomous vehicle, a sensor for sensing an object outside the vehicle is provided.

Sensing of the sensor may not be satisfactorily performed depending on the field of view of the sensor and road situation. In the case in which sensing of the sensor is not satisfactorily performed, the probability of the occurrence of an accident may increase.

### DISCLOSURE

### Technical Problem

The present invention has been made in view of the above problems, and it is an object of the present invention to provide a traveling system capable of providing a traveling trajectory in order to secure the field of view of a sensor.

It is another object of the present invention to provide a vehicle including the traveling system.

The objects of the present invention are not limited to the above-mentioned object, and other objects that have not been mentioned above will become evident to those skilled in the art from the following description.

### Technical Solution

In accordance with the present invention, the above objects can be accomplished by the provision of a traveling system including an object detection device including at least one sensor and a processor configured to acquire road situation information, to determine an expected traveling trajectory of a vehicle based on information about the field of view of the sensor and the road situation information, and to provide a signal for controlling at least one of steering, braking, or acceleration based on the expected traveling trajectory.

The details of other embodiments are included in the following description and the accompanying drawings.

### Advantageous Effects

According to embodiments of the present invention, one or more of the following effects are provided.

First, it is possible to determine a traveling trajectory of a vehicle based on the field of view of a sensor and road situation information, whereby it is possible to increase the probability of the sensor sensing an object.

Second, it is possible to reduce the probability of the occurrence of an accident as the sensing probability is increased.

Third, it is possible to determine the traveling trajectory based on each condition, such as a curved section, an intersection section, or a straight section, whereby it is possible to perform adaptive traveling depending on the condition.

It should be noted that effects of the present invention are not limited to the effects of the present invention as mentioned above, and other unmentioned effects of the present invention will be clearly understood by those skilled in the art from the following claims.

### DESCRIPTION OF DRAWINGS

FIG. 1 is a view showing the external appearance of a vehicle according to an embodiment of the present invention.

FIG. 2 is a view showing the exterior of the vehicle according to the embodiment of the present invention when viewed at various angles.

FIGS. 3 and 4 are views showing the interior of the vehicle according to the embodiment of the present invention.

FIGS. 5 and 6 are reference views illustrating an object according to an embodiment of the present invention.

FIG. 7 is a reference block diagram illustrating the vehicle according to the embodiment of the present invention.

FIG. 8 is a view showing the construction of a traveling system according to an embodiment of the present invention.

FIG. 9 is a flowchart of the traveling system according to the embodiment of the present invention.

FIG. 10 is a reference view illustrating an operation of acquiring road situation information according to an embodiment of the present invention.

FIG. 11 is a reference view illustrating a sensor according to an embodiment of the present invention.

FIGS. 12a to 12c are reference views illustrating the operation of the traveling system when the vehicle travels on a curved section according to an embodiment of the present invention.

FIGS. 13a to 13e are reference views illustrating the operation of the traveling system when the vehicle travels on an intersection section according to an embodiment of the present invention.

FIGS. 14a to 14c are reference views illustrating the operation of the traveling system when the vehicle travels on a straight section according to an embodiment of the present invention.

### BEST MODE

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In the following description, with respect to constituent elements used in the following description, the suffixes “module” and “unit” are used or combined with each other only in consideration of ease in the preparation of the specification, and do not have or serve different meanings. Also, in the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents and substitutions included in the scope and sprit of the present invention.

It will be understood that, although the terms “first,” “second,” etc., may be used herein to describe various components, these components should not be limited by these terms. These terms are only used to distinguish one component from another component.

It will be understood that, when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless the context clearly indicates otherwise.

In the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

A vehicle as described in this specification may be a concept including a car and a motorcycle. Hereinafter, a car will be described as an example of the vehicle.

A vehicle as described in this specification may include all of an internal combustion engine vehicle including an engine as a power source, a hybrid vehicle including both an engine and an electric motor as a power source, and an electric vehicle including an electric motor as a power source.

In the following description, “the left side of the vehicle” refers to the left side in the traveling direction of the vehicle, and “the right side of the vehicle” refers to the right side in the traveling direction of the vehicle.

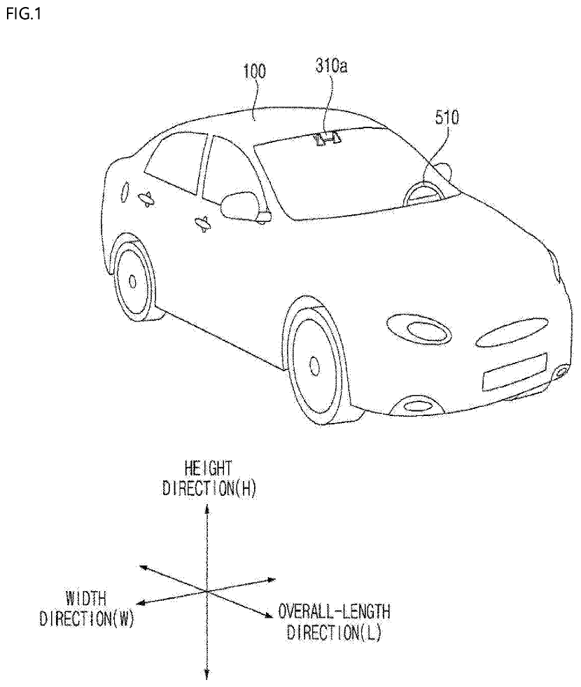

FIG. 1 is a view showing the external appearance of a vehicle according to an embodiment of the present invention.

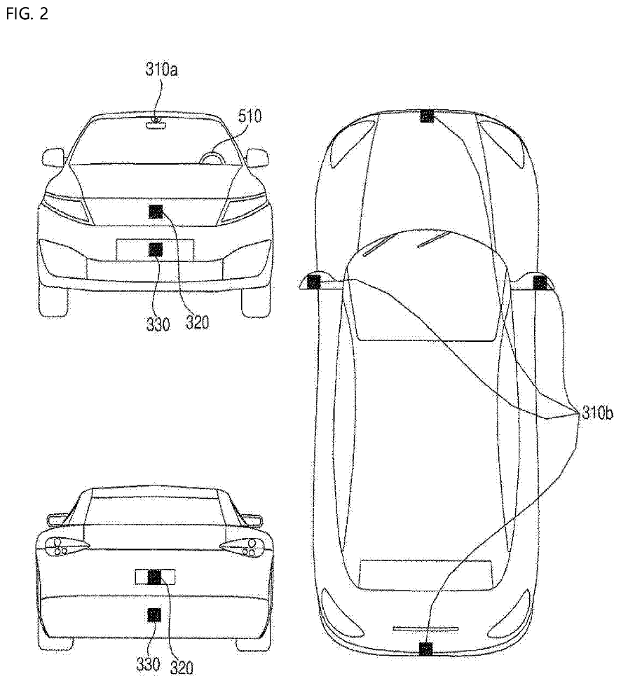

FIG. 2 is a view showing the exterior of the vehicle according to the embodiment of the present invention when viewed at various angles.

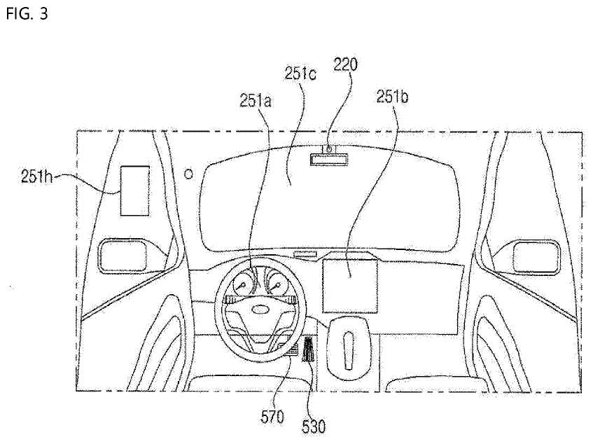

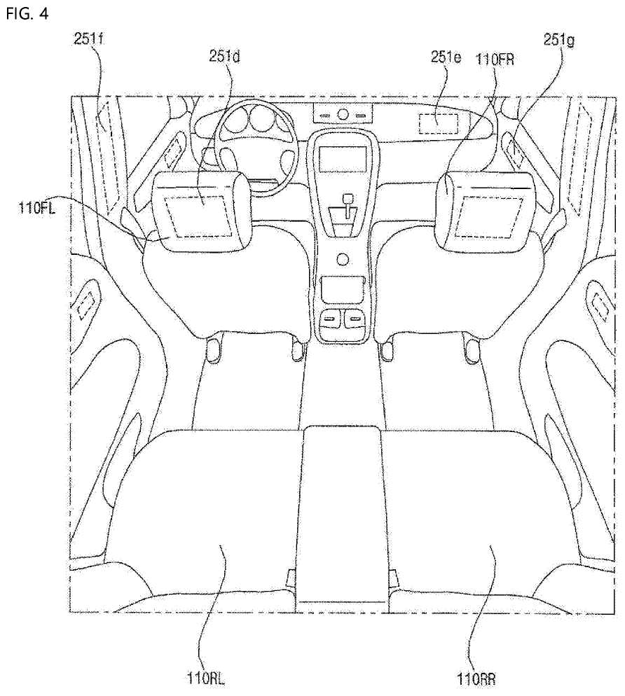

FIGS. 3 and 4 are views showing the interior of the vehicle according to the embodiment of the present invention.

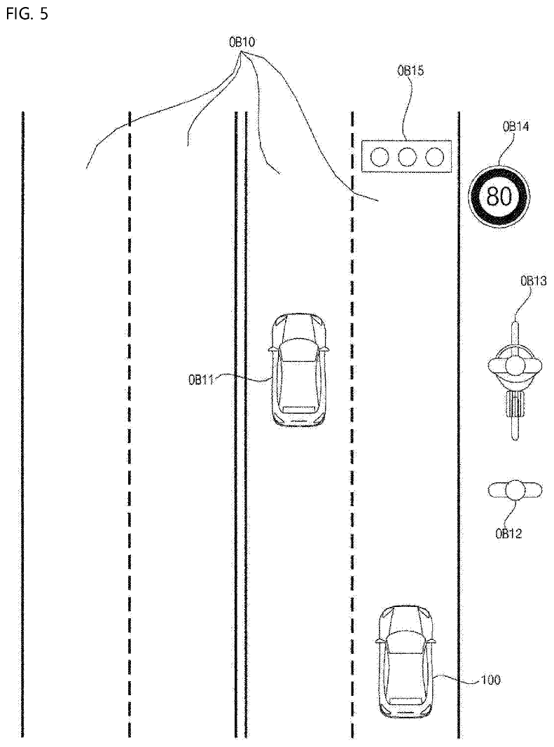

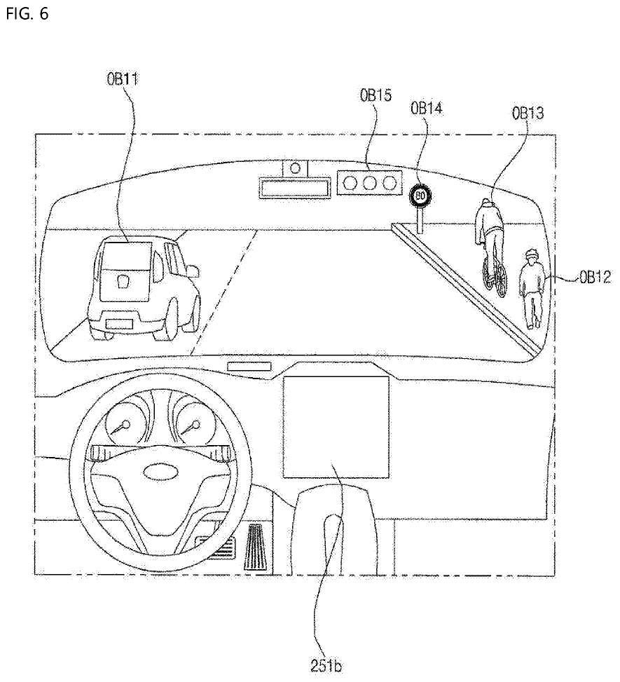

FIGS. 5 and 6 are reference views illustrating an object according to an embodiment of the present invention.

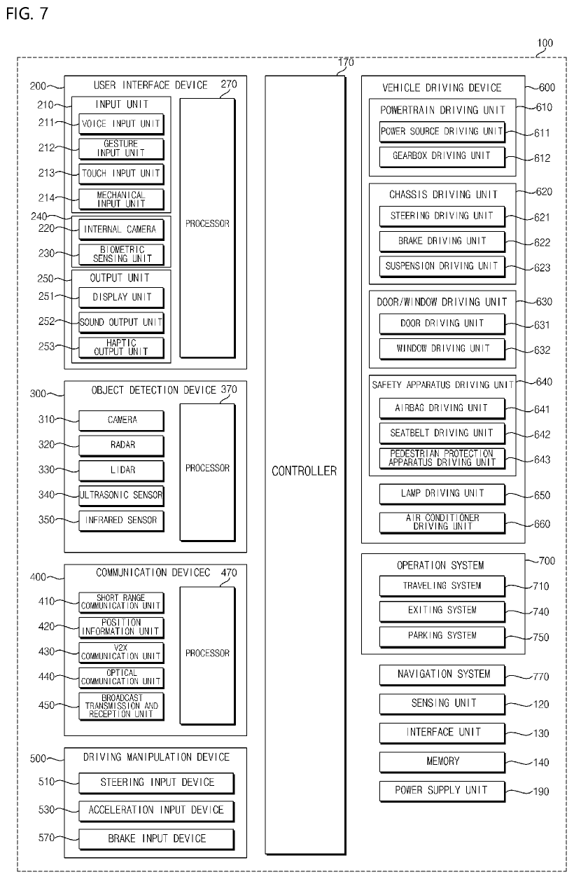

FIG. 7 is a reference block diagram illustrating the vehicle according to the embodiment of the present invention.

Referring to FIGS. 1 to 7, the vehicle 100 may include wheels configured to be rotated by a power source and a steering input device 510 configured to adjust the advancing direction of the vehicle 100.

The vehicle 100 may be an autonomous vehicle.

The vehicle 100 may switch between an autonomous mode and a manual mode based on user input.

For example, the vehicle 100 may switch from the manual mode to the autonomous mode or from the autonomous mode to the manual mode based on user input received through a user interface device 200.

The vehicle 100 may switch to the autonomous mode or to the manual mode based on traveling status information.

The traveling status information may include at least one of object information outside the vehicle, navigation information, or vehicle state information.

For example, the vehicle 100 may switch from the manual mode to the autonomous mode or from the autonomous mode to the manual mode based on traveling status information generated by an object detection device 300.

For example, the vehicle 100 may switch from the manual mode to the autonomous mode or from the autonomous mode to the manual mode based on traveling status information received through a communication device 400.

The vehicle 100 may switch from the manual mode to the autonomous mode or from the autonomous mode to the manual mode based on information, data, or a signal provided by an external device.

In the case in which the vehicle 100 is operated in the autonomous mode, the autonomous vehicle 100 may be operated based on an operation system 700.

For example, the autonomous vehicle 100 may be operated based on information, data, or a signal provided by a traveling system 710, an exiting system 740, or a parking system 750.

In the case in which the vehicle 100 is operated in the manual mode, the autonomous vehicle 100 may receive user input for driving through a driving manipulation device 500. The vehicle 100 may be operated based on user input received through the driving manipulation device 500.

“Overall length” means the length from the front end to the rear end of the vehicle, “width” means the width of the vehicle 100, and “height” means the length from the lower end of each wheel to a roof of the vehicle 100. In the following description, “overall-length direction L” may mean a direction based on which the overall length of the vehicle 100 is measured, “width direction W” may mean a direction based on which the width of the vehicle 100 is measured, and “height direction H” may mean a direction based on which the height of the vehicle 100 is measured.

As exemplarily shown in FIG. 7, the vehicle 100 may include a user interface device 200, an object detection device 300, a communication device 400, a driving manipulation device 500, a vehicle driving device 600, an operation system 700, a navigation system 770, a sensing unit 120, an interface unit 130, a memory 140, a controller 170, and a power supply unit 190.

In some embodiments, the vehicle 100 may further include components other than the components that are described in this specification, or may not include some of the components that are described herein.

The user interface device 200 is a device for communication between the vehicle 100 and a user. The user interface device 200 may receive user input and may provide information generated by the vehicle 100 to the user. The vehicle 100 may realize a user interface (UI) or a user experience (UX) through the user interface device 200.

The user interface device 200 may include an input unit 210, an internal camera 220, a biometric sensing unit 230, an output unit 250, and a processor 270.

In some embodiments, the user interface device 200 may further include components other than the components that are described herein, or may not include some of the components that are described herein.

The input unit 210 is configured to receive information from the user. Data collected by the input unit 210 may be analyzed by the processor 270 and may be processed as a control command of the user.

The input unit 210 may be disposed in the vehicle. For example, the input unit 210 may be disposed in a portion of a steering wheel, a portion of an instrument panel, a portion of a seat, a portion of each pillar, a portion of a door, a portion of a center console, a portion of a head lining, a portion of a sun visor, a portion of a windshield, or a portion of a window.

The input unit 210 may include a voice input unit 211, a gesture input unit 212, a touch input unit 213, and a mechanical input unit 214.

The voice input unit 211 may convert the user voice input into an electrical signal. The converted electrical signal may be provided to the processor 270 or the controller 170.

The voice input unit 211 may include one or more microphones.

The gesture input unit 212 may convert user gesture input into an electrical signal. The converted electrical signal may be provided to the processor 270 or the controller 170.

The gesture input unit 212 may include at least one of an infrared sensor or an image sensor for sensing user gesture input.

In some embodiments, the gesture input unit 212 may sense three-dimensional user gesture input. To this end, the gesture input unit 212 may include a light output unit for outputting a plurality of infrared beams or a plurality of image sensors.

The gesture input unit 212 may sense the three-dimensional user gesture input through a time of flight (TOF) scheme, a structured light scheme, or a disparity scheme.

The touch input unit 213 may convert user touch input into an electrical signal. The converted electrical signal may be provided to the processor 270 or the controller 170.

The touch input unit 213 may include a touch sensor for sensing user touch input.

In some embodiments, the touch input unit 213 may be integrated into a display unit 251 in order to realize a touchscreen. The touchscreen may provide both an input interface and an output interface between the vehicle 100 and the user.

The mechanical input unit 214 may include at least one of a button, a dome switch, a jog wheel, or a jog switch. An electrical signal generated by the mechanical input unit 214 may be provided to the processor 270 or the controller 170.

The mechanical input unit 214 may be disposed in a steering wheel, a center fascia, a center console, a cockpit module, a door, etc.

The internal camera 220 may acquire an image inside the vehicle. The processor 270 may sense the state of the user based on the image inside the vehicle. The processor 270 may acquire gaze information of the user from the image inside the vehicle. The processor 270 may sense user gesture from the image inside the vehicle.

The biometric sensing unit 230 may acquire biometric information of the user. The biometric sensing unit 230 may include a sensor capable of acquiring the biometric information of the user, and may acquire fingerprint information, heart rate information, etc. of the user using the sensor. The biometric information may be used to authenticate the user.

The output unit 250 is configured to generate output related to visual sensation, aural sensation, or tactile sensation.

The output unit 250 may include at least one of a display unit 251, a sound output unit 252, or a haptic output unit 253.

The display unit 251 may display a graphical object corresponding to various kinds of information.

The display unit 251 may include at least one of a liquid crystal display (LCD), a thin film transistor-liquid crystal display (TFT LCD), an organic light-emitting diode (OLED), a flexible display, a 3D display, or an e-ink display.

The display unit 251 may be connected to the touch input unit 213 in a layered structure, or may be formed integrally with the touch input unit, so as to realize a touchscreen.

The display unit 251 may be realized as a head-up display (HUD). In the case in which the display unit 251 is realized as the HUD, the display unit 251 may include a projection module in order to output information through an image projected on the windshield or the window.

The display unit 251 may include a transparent display. The transparent display may be attached to the windshield or the window.

The transparent display may display a predetermined screen while having predetermined transparency. In order to have transparency, the transparent display may include at least one of a transparent thin film electroluminescent (TFEL) display, a transparent organic light-emitting diode (OLED) display, a transparent Liquid Crystal Display (LCD), a transmissive type transparent display, or a transparent light emitting diode (LED) display. The transparency of the transparent display may be adjusted.

Meanwhile, the user interface device 200 may include a plurality of display units 251a to 251g.

The display unit 251 may be realized in a portion of the steering wheel, portions of the instrument panel (251a, 251b, and 251e), a portion of the seat (251d), a portion of each pillar (251f), a portion of the door (251g), a portion of the center console, a portion of the head lining, a portion of the sun visor, a portion of the windshield (251c), or a portion of the window (251h).

The sound output unit 252 converts an electrical signal provided from the processor 270 or the controller 170 into an audio signal, and outputs the converted audio signal. To this end, the sound output unit 252 may include one or more speakers.

The haptic output unit 253 may generate tactile output. For example, the haptic output unit 253 may vibrate the steering wheel, a safety belt, and seats 110FL, 110FR, 110RL, and 110RR such that the user recognizes the output.

The processor 270 may control the overall operation of each unit of the user interface device 200.

In some embodiments, the user interface device 200 may include a plurality of processors 270, or may not include the processor 270.

In the case in which the processor 270 is not included in the user interface device 200, the user interface device 200 may be operated under the control of a processor of another device in the vehicle 100 or the controller 170.

Meanwhile, the user interface device 200 may be referred to as a display device for vehicles.

The user interface device 200 may be operated under the control of the controller 170.

The object detection device 300 is a device that detects an object located outside the vehicle 100. The object detection device 300 may generate object information based on sensing data.

The object information may include information about presence or absence of an object, information about the position of the object, information about the distance between the vehicle 100 and the object, and information about the speed of the vehicle 100 relative to the object.

The object may be various bodies related to the operation of the vehicle 100.

Referring to FIGS. 5 and 6, the object O may include a lane OB10, another vehicle OB11, a pedestrian OB12, a two-wheeled vehicle OB13, a traffic signal OB14 and OB15, light, a road, a structure, a speed bump, a geographical body, and an animal.

The lane OB10 may be a traveling lane, a lane next to the traveling lane, or a lane in which an opposite vehicle travels. The lane OB10 may be a concept including left and right lines that define the lane. The lane may be a concept including an intersection.

The vehicle OB11 may be a vehicle that is traveling around the vehicle 100. This vehicle may be a vehicle located within a predetermined distance from the vehicle 100. For example, the vehicle OB11 may be a vehicle that precedes or follows the vehicle 100.

The pedestrian OB12 may be a person located around the vehicle 100. The pedestrian OB12 may be a person located within a predetermined distance from the vehicle 100. For example, the pedestrian OB12 may be a person located on a sidewalk or a roadway.

The two-wheeled vehicle OB13 may be a vehicle that is located around the vehicle 100 and is movable using two wheels. The two-wheeled vehicle OB13 may be a vehicle that is located within a predetermined distance from the vehicle 100 and has two wheels. For example, the two-wheeled vehicle OB13 may be a motorcycle or a bicycle located on a sidewalk or a roadway.

The traffic signal may include a traffic light OB15, a traffic board OB14, and a pattern or text marked on the surface of a road.

The light may be light generated by a lamp of another vehicle. The light may be light generated by a streetlight. The light may be sunlight.

The road may include a road surface, a curve, and a slope, such as an upward slope or a downward slope.

The structure may be a body that is located around a road and fixed to the ground. For example, the structure may include a streetlight, a roadside tree, a building, an electric pole, a signal light, a bridge, a curbstone, and a wall.

The geographical body may include a mountain and a hill.

Meanwhile, the object may be classified as a moving object or a stationary object. For example, the moving object may be a concept including another vehicle that is moving and a pedestrian who is moving. For example, the stationary object may be a concept including a traffic signal, a road, a structure, another vehicle that is in a stopped state, and a pedestrian who is in a stopped state.

The object detection device 300 may include a camera 310, a radar 320, a lidar 330, an ultrasonic sensor 340, an infrared sensor 350, and a processor 370.

In some embodiments, the object detection device 300 may further include components other than the components that are described herein, or may not include some of the components that are described herein.

The camera 310 may be located at an appropriate position outside the vehicle in order to acquire an image outside the vehicle. The camera 310 may be a mono camera, a stereo camera 310a, an around view monitoring (AVM) camera 310b, or a 360-degree camera.

The camera 310 may acquire information of the object, distance information from the object, or speed information relative to the object using various image processing algorithms.

For example, the camera 310 may acquire the distance information from the object and the speed information relative to the object based on a change in the size of the object over time in an acquired image.

For example, the camera 310 may acquire the distance information from the object and the speed information relative to the object through a pin hole model or road surface profiling.

For example, the camera 310 may be disposed in the vehicle so as to be adjacent to a front windshield in order to acquire an image ahead of the vehicle. Alternatively, the camera 310 may be disposed around a front bumper or a radiator grill.

For example, the camera 310 may be disposed in the vehicle so as to be adjacent to a rear glass in order to acquire an image behind the vehicle. Alternatively, the camera 310 may be disposed around a rear bumper, a trunk, or a tail gate.

For example, the camera 310 may be disposed in the vehicle so as to be adjacent to at least one of side windows in order to acquire an image beside the vehicle. Alternatively, the camera 310 may be disposed around a side mirror, a fender, or a door.

The camera 310 may provide the acquired image to the processor 370.

The radar 320 may include an electromagnetic wave transmission unit and an electromagnetic wave reception unit. The radar 320 may be realized using a pulse radar scheme or a continuous wave radar scheme based on an electric wave emission principle. In the continuous wave radar scheme, the radar 320 may be realized using a frequency modulated continuous wave (FMCW) scheme or a frequency shift keying (FSK) scheme based on a signal waveform.

The radar 320 may detect an object based on a time of flight (TOF) scheme or a phase-shift scheme through the medium of an electromagnetic wave, and may detect the position of the detected object, the distance from the detected object, and the speed relative to the detected object.

The radar 320 may be disposed at an appropriate position outside the vehicle in order to sense an object located ahead of, behind, or beside the vehicle.

The lidar 330 may include a laser transmission unit and a laser reception unit. The lidar 330 may be realized using a time of flight (TOF) scheme or a phase-shift scheme.

The lidar 330 may be of a driving type or a non-driving type.

The driving type lidar 330 may be rotated by a motor in order to detect an object around the vehicle 100.

The non-driving type lidar 330 may detect an object located within a predetermined range from the vehicle 100 through light steering. The vehicle 100 may include a plurality of non-driving type lidars 330.

The lidar 330 may detect an object based on a time of flight (TOF) scheme or a phase-shift scheme through the medium of laser light, and may detect the position of the detected object, the distance from the detected object, and the speed relative to the detected object.

The lidar 330 may be disposed at an appropriate position outside the vehicle in order to sense an object located ahead of, behind, or beside the vehicle.

The ultrasonic sensor 340 may include an ultrasonic wave transmission unit and an ultrasonic wave reception unit. The ultrasonic sensor 340 may detect an object based on an ultrasonic wave, and may detect the position of the detected object, the distance from the detected object, and the speed relative to the detected object.

The ultrasonic sensor 340 may be disposed at an appropriate position outside the vehicle in order to sense an object located ahead of, behind, or beside the vehicle.

The infrared sensor 350 may include an infrared transmission unit and an infrared reception unit. The infrared sensor 340 may detect an object based on infrared light, and may detect the position of the detected object, the distance from the detected object, and the speed relative to the detected object.

The infrared sensor 350 may be disposed at an appropriate position outside the vehicle in order to sense an object located ahead of, behind, or beside the vehicle.

The processor 370 may control the overall operation of each unit of the object detection device 300.

The processor 370 may compare data sensed by the camera 310, the radar 320, the lidar 330, the ultrasonic sensor 340, and the infrared sensor 350 with pre-stored data in order to detect or classify an object.

The processor 370 may detect and track an object based on an acquired image. The processor 370 may calculate the distance from the object and the speed relative to the object through an image processing algorithm.

For example, the processor 370 may acquire the distance information from the object and the speed information relative to the object based on a change in the size of the object over time in an acquired image.

For example, the processor 370 may acquire the distance information from the object and the speed information relative to the object through a pin hole model or road surface profiling.

For example, the processor 370 may acquire the distance information from the object and the speed information relative to the object from a stereo image acquired by the stereo camera 310a based on disparity information.

The processor 370 may detect and track an object based on a reflected electromagnetic wave returned as the result of a transmitted electromagnetic wave being reflected by the object. The processor 370 may calculate the distance from the object and the speed relative to the object based on the electromagnetic wave.

The processor 370 may detect and track an object based on reflected laser light returned as the result of transmitted laser light being reflected by the object. The processor 370 may calculate the distance from the object and the speed relative to the object based on the laser light.

The processor 370 may detect and track an object based on a reflected ultrasonic wave returned as the result of a transmitted ultrasonic wave being reflected by the object. The processor 370 may calculate the distance from the object and the speed relative to the object based on the ultrasonic wave.

The processor 370 may detect and track an object based on reflected infrared light returned as the result of transmitted infrared light being reflected by the object. The processor 370 may calculate the distance from the object and the speed relative to the object based on the infrared light.

In some embodiments, the object detection device 300 may include a plurality of processors 370, or may not include the processor 370. For example, each of the camera 310, the radar 320, the lidar 330, the ultrasonic sensor 340, and the infrared sensor 350 may include a processor.

In the case in which the processor 370 is not included in the object detection device 300, the object detection device 300 may be operated under the control of a processor of another device in the vehicle 100 or the controller 170.

The object detection device 300 may be operated under the control of the controller 170.

The communication device 400 is a device for communication with an external device. Here, the external device may be another vehicle, a mobile terminal, or a server.

The communication device 400 may include at least one of a transmission antenna, a reception antenna, a radio frequency (RF) circuit capable of realizing various communication protocols, or an RF element in order to perform communication.

The communication device 400 may include a short range communication unit 410, a position information unit 420, a V2X communication unit 430, an optical communication unit 440, a broadcast transmission and reception unit 450, an intelligent transport system (ITS) communication unit 460, and a processor 470.

In some embodiments, the communication device 400 may further include components other than the components that are described herein, or may not include some of the components that are described herein.

The short range communication unit 410 is a unit for short range communication. The short range communication unit 410 may support short range communication using at least one of Bluetooth™, radio frequency identification (RFID), infrared data association (IrDA), ultra-wideband (UWB), ZigBee, near field communication (NFC), wireless-fidelity (Wi-Fi), Wi-Fi Direct, or wireless universal serial bus (Wireless USB) technology.

The short range communication unit 410 may form a short range wireless area network in order to perform short range communication between the vehicle 100 and at least one external device.

The position information unit 420 is a unit for acquiring position information of the vehicle 100. For example, the position information unit 420 may include a global positioning system (GPS) module or a differential global positioning system (DGPS) module.

The V2X communication unit 430 is a unit for wireless communication with a server (V2I: Vehicle to Infrastructure), another vehicle (V2V: Vehicle to Vehicle), or a pedestrian (V2P: Vehicle to Pedestrian). The V2X communication unit 430 may include an RF circuit capable of realizing protocols for communication with infrastructure (V2I), communication between vehicles (V2V), and communication with a pedestrian (V2P).

The optical communication unit 440 is a unit for performing communication with an external device through the medium of light. The optical communication unit 440 may include an optical transmission unit for converting an electrical signal into an optical signal and transmitting the optical signal and an optical reception unit for converting a received optical signal into an electrical signal.

In some embodiments, the optical transmission unit may be integrated into a lamp included in the vehicle 100.

The broadcast transmission and reception unit 450 is a unit for receiving a broadcast signal from an external broadcasting administration server through a broadcasting channel or transmitting a broadcast signal to the broadcasting administration server. The broadcasting channel may include a satellite channel and a terrestrial channel. The broadcast signal may include a TV broadcast signal, a radio broadcast signal, and a data broadcast signal.

The ITS communication unit 460 may exchange information, data, or a signal with a transport system. The ITS communication unit 460 may provide acquired information or data to the transport system. The ITS communication unit 460 may receive information, data, or a signal from the transport system. For example, the ITS communication unit 460 may receive road traffic information from the transport system, and may provide the same to the controller 170. For example, the ITS communication unit 460 may receive a control signal from the transport system, and may provide the same to the controller 170 or a processor provided in the vehicle 100.

The processor 470 may control the overall operation of each unit of the communication device 400.

In some embodiments, the communication device 400 may include a plurality of processors 470, or may not include the processor 470.

In the case in which the processor 470 is not included in the communication device 400, the communication device 400 may be operated under the control of a processor of another device in the vehicle 100 or the controller 170.

Meanwhile, the communication device 400 may realize a display device for vehicles together with the user interface device 200. In this case, the display device for vehicles may be referred to as a telematics device or an audio video navigation (AVN) device.

The communication device 400 may be operated under the control of the controller 170.

The driving manipulation device 500 is a device that receives user input for driving.

In the manual mode, the vehicle 100 may be operated based on a signal provided by the driving manipulation device 500.

The driving manipulation device 500 may include a steering input device 510, an acceleration input device 530, and a brake input device 570.

The steering input device 510 may receive user input about the advancing direction of the vehicle 100. Preferably, the steering input device 510 is configured in the form of a wheel, which is rotated for steering input. In some embodiments, the steering input device 510 may be configured in the form of a touchscreen, a touch pad, or a button.

The acceleration input device 530 may receive user input for acceleration of the vehicle 100. The brake input device 570 may receive user input for deceleration of the vehicle 100. Preferably, each of the acceleration input device 530 and the brake input device 570 is configured in the form of a pedal. In some embodiments, the acceleration input device or the brake input device may be configured in the form of a touchscreen, a touch pad, or a button.

The driving manipulation device 500 may be operated under the control of the controller 170.

The vehicle driving device 600 is a device that electrically controls driving of each device in the vehicle 100.

The vehicle driving device 600 may include a powertrain driving unit 610, a chassis driving unit 620, a door/window driving unit 630, a safety apparatus driving unit 640, a lamp driving unit 650, and an air conditioner driving unit 660.

In some embodiments, the vehicle driving device 600 may further include components other than the components that are described herein, or may not include some of the components that are described herein.

Meanwhile, the vehicle driving device 600 may include a processor. Each unit of the vehicle driving device 600 may include a processor.

The powertrain driving unit 610 may control the operation of a powertrain device.

The powertrain driving unit 610 may include a power source driving unit 611 and a gearbox driving unit 612.

The power source driving unit 611 may control a power source of the vehicle 100.

For example, in the case in which the power source is an engine based on fossil fuel, the power source driving unit 611 may electronically control the engine. As a result, output torque of the engine may be controlled. The power source driving unit 611 may adjust the output torque of the engine under the control of the controller 170.

For example, in the case in which the power source is a motor based on electric energy, the power source driving unit 611 may control the motor. The power source driving unit 611 may adjust rotational speed, torque, etc. of the motor under the control of the controller 170.

The gearbox driving unit 612 may control a gearbox.

The gearbox driving unit 612 may adjust the state of the gearbox. The gearbox driving unit 612 may adjust the state of the gearbox to drive D, reverse R, neutral N, or park P.

Meanwhile, in the case in which the power source is an engine, the gearbox driving unit 612 may adjust the engagement between gears in the state of forward movement D.

The chassis driving unit 620 may control the operation of a chassis device.

The chassis driving unit 620 may include a steering driving unit 621, a brake driving unit 622, and a suspension driving unit 623.

The steering driving unit 621 may electronically control a steering apparatus in the vehicle 100. The steering driving unit 621 may change the advancing direction of the vehicle.

The brake driving unit 622 may electronically control a brake apparatus in the vehicle 100. For example, the brake driving unit may control the operation of a brake disposed at each wheel in order to reduce the speed of the vehicle 100.

Meanwhile, the brake driving unit 622 may individually control a plurality of brakes. The brake driving unit 622 may perform control such that braking forces applied to the wheels are different from each other.

The suspension driving unit 623 may electronically control a suspension apparatus in the vehicle 100. For example, in the case in which the surface of a road is irregular, the suspension driving unit 623 may control the suspension apparatus in order to reduce vibration of the vehicle 100.

Meanwhile, the suspension driving unit 623 may individually control a plurality of suspensions.

The door/window driving unit 630 may electronically control a door apparatus or a window apparatus in the vehicle 100.

The door/window driving unit 630 may include a door driving unit 631 and a window driving unit 632.

The door driving unit 631 may control the door apparatus. The door driving unit 631 may control opening or closing of a plurality of doors included in the vehicle 100. The door driving unit 631 may control opening or closing of a trunk or a tail gate. The door driving unit 631 may control opening or closing of a sunroof.

The window driving unit 632 may electronically control the window apparatus. The window driving unit may control opening or closing of a plurality of windows included in the vehicle 100.

The safety apparatus driving unit 640 may electronically control various safety apparatuses in the vehicle 100.

The safety apparatus driving unit 640 may include an airbag driving unit 641, a seatbelt driving unit 642, and a pedestrian protection apparatus driving unit 643.

The airbag driving unit 641 may electronically control an airbag apparatus in the vehicle 100. For example, when danger is sensed, the airbag driving unit 641 may perform control such that an airbag is inflated.

The seatbelt driving unit 642 may electronically control a seatbelt apparatus in the vehicle 100.

For example, when danger is sensed, the seatbelt driving unit 642 may perform control such that passengers are fixed to the 110FL, 110FR, 110RL, and 110RR using seatbelts.

The pedestrian protection apparatus driving unit 643 may electronically control a hood lift and a pedestrian airbag. For example, when collision with a pedestrian is sensed, the pedestrian protection apparatus driving unit 643 may perform control such that the hood lift is raised and the pedestrian airbag is inflated.

The lamp driving unit 650 may electronically control various lamp apparatuses in the vehicle 100.

The air conditioner driving unit 660 may electronically control an air conditioner in the vehicle 100. For example, in the case in which the temperature in the vehicle is high, the air conditioner driving unit 660 may perform control such that the air conditioner is operated to supply cold air into the vehicle.

The vehicle driving device 600 may include a processor. Each unit of the vehicle driving device 600 may include a processor.

The vehicle driving device 600 may be operated under the control of the controller 170.

The operation system 700 is a system that controls various operations of the vehicle 100. The operation system 700 may be operated in the autonomous mode.

The operation system 700 may include a traveling system 710, an exiting system 740, or a parking system 750.

In some embodiments, the operation system 700 may further include components other than the components that are described herein, or may not include some of the components that are described herein.

Meanwhile, the operation system 700 may include a processor. Each unit of the operation system 700 may include a processor.

Meanwhile, in some embodiments, the operation system 700 may be a low-level concept of the controller 170 in the case of being realized in the form of software.

Meanwhile, in some embodiments, the operation system 700 may be a concept including at least one of the user interface device 200, the object detection device 300, the communication device 400, the driving manipulation device 500, the vehicle driving device 600, the navigation system 770, the sensing unit 120, or the controller 170.

The traveling system 710 may perform traveling of the vehicle 100.

The traveling system 710 may receive navigation information from the navigation system 770, and may provide a control signal to the vehicle driving device 600 in order to perform traveling of the vehicle 100.

The traveling system 710 may receive object information from the object detection device 300, and may provide a control signal to the vehicle driving device 600 in order to perform traveling of the vehicle 100.

The traveling system 710 may receive a signal from an external device through the communication device 400, and may provide a control signal to the vehicle driving device 600 in order to perform traveling of the vehicle 100.

The traveling system 710 may be a system concept including at least one of the user interface device 200, the object detection device 300, the communication device 400, the driving manipulation device 500, the vehicle driving device 600, the navigation system 770, the sensing unit 120, or the controller 170 in order to perform traveling of the vehicle 100.

The traveling system 710 may be referred to as a vehicle traveling control device.

The exiting system 740 may perform exiting of the vehicle 100.

The exiting system 740 may receive navigation information from the navigation system 770, and may provide a control signal to the vehicle driving device 600 in order to perform exiting of the vehicle 100.

The exiting system 740 may receive object information from the object detection device 300, and may provide a control signal to the vehicle driving device 600 in order to perform exiting of the vehicle 100.

The exiting system 740 may receive a signal from an external device through the communication device 400, and may provide a control signal to the vehicle driving device 600 in order to perform exiting of the vehicle 100.

The exiting system 740 may be a system concept including at least one of the user interface device 200, the object detection device 300, the communication device 400, the driving manipulation device 500, the vehicle driving device 600, the navigation system 770, the sensing unit 120, or the controller 170 in order to perform exiting of the vehicle 100.

The exiting system 740 may be referred to as a vehicle exiting control device.

The parking system 750 may perform parking of the vehicle 100.

The parking system 750 may receive navigation information from the navigation system 770, and may provide a control signal to the vehicle driving device 600 in order to perform parking of the vehicle 100.

The parking system 750 may receive object information from the object detection device 300, and may provide a control signal to the vehicle driving device 600 in order to perform parking of the vehicle 100.

The parking system 750 may receive a signal from an external device through the communication device 400, and may provide a control signal to the vehicle driving device 600 in order to perform parking of the vehicle 100.

The parking system 750 may be a system concept including at least one of the user interface device 200, the object detection device 300, the communication device 400, the driving manipulation device 500, the vehicle driving device 600, the navigation system 770, the sensing unit 120, or the controller 170 in order to perform parking of the vehicle 100.

The parking system 750 may be referred to as a vehicle parking control device.

The navigation system 770 may provide navigation information. The navigation information may include at least one of map information, information about a set destination, information about a route based on the setting of the destination, information about various objects on the route, lane information, or information about the current position of the vehicle.

The navigation system 770 may include a memory and a processor. The memory may store the navigation information. The processor may control the operation of the navigation system 770.

In some embodiments, the navigation system 770 may receive information from an external device through the communication device 400 in order to update pre-stored information.

In some embodiments, the navigation system 770 may be classified as a low-level component of the user interface device 200.

The sensing unit 120 may sense the state of the vehicle. The sensing unit 120 may include an inertial navigation unit (IMU) sensor, a collision sensor, a wheel sensor, a speed sensor, a slope sensor, a weight sensor, a heading sensor, a position module, a vehicle forward/rearward movement sensor, a battery sensor, a fuel sensor, a tire sensor, a steering wheel rotation sensor, an in-vehicle temperature sensor, an in-vehicle humidity sensor, an ultrasonic sensor, an ambient light sensor, an accelerator pedal position sensor, and a brake pedal position sensor.

Meanwhile, the inertial navigation unit (IMU) sensor may include one or more of an acceleration sensor, a gyro sensor, and a magnetic sensor.

The sensing unit 120 may acquire vehicle orientation information, vehicle motion information, vehicle yaw information, vehicle roll information, vehicle pitch information, vehicle collision information, vehicle direction information, vehicle position information (GPS information), vehicle angle information, vehicle speed information, vehicle acceleration information, vehicle tilt information, vehicle forward/rearward movement information, battery information, fuel information, tire information, vehicle lamp information, in-vehicle temperature information, in-vehicle humidity information, and a sensing signal, such as a steering wheel rotation angle, ambient light outside the vehicle, pressure applied to an accelerator pedal, and pressure applied to a brake pedal.

In addition, the sensing unit 120 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, and a crank angle sensor (CAS).

The sensing unit 120 may generate vehicle state information based on sensing data. The vehicle state information may be information generated based on data sensed by various sensors provided in the vehicle.

For example, the vehicle state information may include vehicle orientation information, vehicle speed information, vehicle tilt information, vehicle weight information, vehicle direction information, vehicle battery information, vehicle fuel information, information about the air pressure of tires of the vehicle, vehicle steering information, in-vehicle temperature information, in-vehicle humidity information, pedal position information, and vehicle engine temperature information.

The interface unit 130 may serve as a path between the vehicle 100 and various kinds of external devices connected thereto. For example, the interface unit 130 may include a port connectable to a mobile terminal, and may be connected to the mobile terminal via the port. In this case, the interface unit 130 may exchange data with the mobile terminal.

Meanwhile, the interface unit 130 may serve as a path for supplying electrical energy to the mobile terminal connected thereto. In the case in which the mobile terminal is electrically connected to the interface unit 130, the interface unit 130 may provide electrical energy, supplied from the power supply unit 190, to the mobile terminal under the control of the controller 170.

The memory 140 is electrically connected to the controller 170. The memory 140 may store basic data about the units, control data necessary to control the operation of the units, and data that are input and output. In a hardware aspect, the memory 140 may be any of various storage devices, such as a ROM, a RAM, an EPROM, a flash drive, and a hard drive. The memory 140 may store various data necessary to perform the overall operation of the vehicle 100, such as a program for processing or control of the controller 170.

In some embodiments, the memory 140 may be integrated into the controller 170, or may be realized as a low-level component of the controller 170.

The controller 170 may control the overall operation of each unit in the vehicle 100. The controller 170 may be referred to as an electronic control unit (ECU).

The power supply unit 190 may supply power necessary to operate each component under the control of the controller 170. In particular, the power supply unit 190 may receive power from a battery in the vehicle.

One or more processors and the controller 170 included in the vehicle 100 may be realized using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or electrical units for performing other functions.

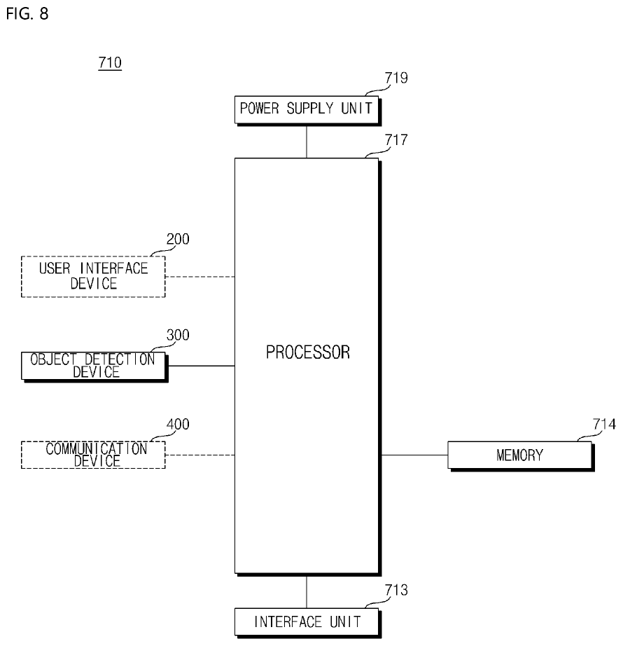

FIG. 8 is a view showing the construction of a traveling system according to an embodiment of the present invention.

The vehicle 100 may include a traveling system 710 and a plurality of wheels configured to be driven based on a control signal generated by the traveling system.

The traveling system 710 may be an autonomous traveling system.

The traveling system 710 may be an advanced driver assistance system.

Referring to FIG. 8, the traveling system 710 may include an object detection device 300, an interface unit 713, a memory 714, a processor 717, and a power supply unit 719.

In some embodiments, the traveling system 710 may further include a user interface device 200 and a communication device 400 individually or in a combined state.

The description of the user interface device 200 shown in FIGS. 1 to 7 may be applied to the display device 200.

The user interface device 200 may output content based on data, information, or a signal generated or processed by the processor 717.

For example, the user interface device 200 may output a manual traveling switching request signal. The user interface device 200 may receive user input for manual traveling switching.

The description of the object detection device 300 shown in FIGS. 1 to 7 may be applied to the object detection device 300.

The object detection device 300 may include one or more sensors.

For example, as previously described, the object detection device 300 may include a camera 310, a radar 320, a lidar 330, an ultrasonic sensor 340, and an infrared sensor 350.

The object detection device 300 may generate road situation information based on sensing data from the one or more sensors.

The object detection device 300 may include a camera sensor 310, a radar sensor 320, a lidar sensor 330, an ultrasonic sensor 340, and an infrared sensor 350.

The description of the communication device 400 shown in FIGS. 1 to 7 may be applied to the communication device 400.

The communication device 400 may communicate with another device.

For example, the communication device 400 may communicate with at least one of another vehicle or an external server.

The communication device 400 may receive data about an object from at least one of another vehicle or an external server.

The communication device 400 may receive road situation information from another device.

The interface unit 713 may exchange information, a signal, or data with another device included in the vehicle 100. The interface unit 713 may transmit the received information, signal, or data to the processor 717. The interface unit 713 may transmit information, a signal, or data generated or processed by the processor 717 to another device included in the vehicle 100. The interface unit 713 may receive information, a signal, or data from another device included in the vehicle 100.

The interface unit 713 may receive traveling status information.

The memory 714 is electrically connected to the processor 717. The memory 714 may store basic data about the units, control data necessary to control the operation of the units, and data that are input and output. In a hardware aspect, the memory 714 may be any of various storage devices, such as a ROM, a RAM, an EPROM, a flash drive, and a hard drive. The memory 714 may store various data necessary to perform the overall operation of the autonomous traveling system 710, such as a program for processing or control of the processor 717.

In some embodiments, the memory 7140 may be integrated into the processor 717, or may be realized as a low-level component of the processor 717.

The processor 717 may be electrically connected to each unit of the autonomous traveling system 710.

The processor 717 may control the overall operation of each unit of the autonomous traveling system 710, The processor 717 may acquire road situation information.

The processor 717 may receive road situation information from the object detection device 300.

The processor 717 may receive road situation information from the communication device 400.

The processor 717 may receive road situation information from the navigation system 770.

The processor 717 may acquire information about the field of view of the sensor.

The processor 717 may acquire information about the field of view of the sensor from the object detection device 300.

The processor 717 may call information about the field of view of the sensor stored in the memory 714.

The processor 717 may determine an expected traveling trajectory of the vehicle 100 based on the information about the field of view of the sensor and road situation information.

The expected traveling trajectory may be defined as a change in the expected position of the vehicle in a predetermined section.

The expected traveling trajectory may be a concept including an expected traveling route.

For example, the processor 717 may determine the expected traveling trajectory of the vehicle such that at least a portion of the field of view of the sensor overlaps a traveling lane.

For example, the processor 717 may determine a traveling lane of the vehicle 100 from among a plurality of lanes in a predetermined section.

For example, the processor 717 may determine the position of the vehicle in the traveling lane in a predetermined section.

The processor 717 may provide a signal for controlling at least one of steering, braking, or acceleration based on the expected traveling trajectory.

The processor 717 may provide a signal for controlling at least one of steering, braking, or acceleration to the vehicle driving device 600.

The processor 717 may determine at least one of the camera sensor 310, the radar sensor 320, the lidar sensor 330, the ultrasonic sensor 340, or the infrared sensor 350 as a main sensor based on road situation information.

The camera sensor 310, the radar sensor 320, the lidar sensor 330, the ultrasonic sensor 340, and the infrared sensor 350 have different fields of view, sensing distances, and recognition rates.

In addition, the recognition rate of each of the camera sensor 310, the radar sensor 320, the lidar sensor 330, the ultrasonic sensor 340, and the infrared sensor 350 is affected by the circumferential environment.

Information about a sensor having a high recognition rate according to road situation information based on data accumulated by a plurality of vehicles may be stored in the server.

Information about a sensor that is suitable depending on road situation information based on data accumulated by a plurality of vehicles may be stored in the server.

The processor 717 may continuously receive information about a sensor that is suitable depending on road situation information through the communication device 400 during traveling.

The processor 717 may determine an expected traveling trajectory of the vehicle 100 based on information about the field of view of a sensor determined as the main sensor and road situation information.

For example, the processor 717 may determine an expected traveling trajectory of the vehicle such that at least a portion of the field of view of a sensor determined as the main sensor overlaps the traveling lane.

The processor 717 may change the field of view of a sensor determined as the main sensor.

For example, the processor 717 may change the field of view of a sensor determined as the main sensor in a hardware scheme or in a software scheme such that the field of view of the sensor covers the traveling lane

The hardware scheme may be defined as changing the field of view of the sensor based on physical movement.

The software scheme may be defined as changing the field of view of the sensor based on an algorithm of the processor 717.

The processor 717 may determine an expected traveling trajectory based on the extent to which a sensing range depending on the field of view of the sensor is covered due to road situation.

For example, the processor 717 may determine an expected traveling trajectory such that an area in which a sensing range depending on the field of view of the sensor is covered due to road situation is minimized.

The processor 717 may determine an expected traveling trajectory based on the extent to which the field of view of the sensor deviates from a road due to road situation.

For example, the processor 717 may determine an expected traveling trajectory such that the extent to which the field of view of the sensor deviates from the road due to road situation is minimized.

The processor 717 may determine an expected traveling trajectory in order to change the traveling lane of the vehicle 100 based on field of view information and the road situation information.

By changing the traveling lane, it is possible to maximally secure a sensing range of the sensor based on the field of view thereof.

The processor 717 may determine an expected traveling trajectory in order to change the position of the vehicle 100 in the traveling lane based on field of view information and the road situation information.

The processor 717 may determine an expected traveling trajectory in order to change the position of the vehicle 100 in the traveling lane such that the vehicle approaches one of two lines defining the traveling lane.

By changing the position of the vehicle 100 in the traveling lane, it is possible to maximally secure a sensing range of the sensor based on the field of view thereof.

The processor 717 may acquire curved section information.

The processor 717 may determine an expected traveling trajectory of the vehicle 100 such that the vehicle 100 moves in a direction opposite the center of curvature of a curve based on the information about the field of view of the sensor and the curved section information.

For example, in the case in which the value of curvature of the curve is equal to or greater than a reference value, the processor 717 may determine an expected traveling trajectory of the vehicle 100 such that the vehicle 100 moves in a direction opposite the center of curvature of the curve.

For example, the processor 717 may determine an expected traveling trajectory in order to change the traveling lane in a direction opposite the center of curvature of the curve. After the traveling lane of the vehicle 100 is changed in a direction opposite the center of curvature of the curve, the processor 717 may determine an expected traveling trajectory in order to change the traveling lane of the vehicle 100 in a direction directed to the center of curvature of the curve. In this way, the vehicle 100 may change the lane when entering a curved section, and may change the lane again after entering the curved section, whereby a sensing range ahead of the vehicle may be maximized.

The processor 717 may acquire information about an object located in an expected change lane through the object detection device 300. In this case, the processor 717 may provide a signal for deceleration or acceleration. After the vehicle 100 is decelerated or accelerated, the processor 717 may provide a signal for changing the lane in a direction opposite the center of curvature of the curve.

For example, the processor 717 may determine an expected traveling trajectory in order to change the position of the vehicle in the traveling lane in a direction opposite the center of curvature of the curve.

The processor 717 may acquire intersection section information.

The processor 717 may acquire information about the route of the vehicle 100 at an intersection from the navigation system 770.

The processor 717 may determine an expected traveling trajectory of the vehicle 100 based on the information about the field of view of the sensor, the intersection section information, and the information about the route of the vehicle 100 at the intersection.

For example, the processor 717 may determine an expected traveling trajectory in order to change the traveling lane.

For example, the processor 717 may determine an expected traveling trajectory in order to change the position of the vehicle in the traveling lane.

In the case in which the route of the vehicle 100 at the intersection is a straight route or a left-turn route, the processor 717 may determine an expected traveling trajectory in order to change the traveling lane to a lane that is closest to the central line, among changeable lanes.

The processor 717 may change the field of view of the sensor in order to sense a lane that another vehicle can enter as the route of the vehicle after the intersection.

The processor 717 may acquire information about an object located in an expected change lane through the object detection device 300. In this case, the processor 717 may provide a signal for deceleration or acceleration. After the vehicle 100 is decelerated or accelerated, the processor 717 may provide a signal for changing the traveling lane to a lane that is closest to the central line, among changeable lanes.

In the case in which the route of the vehicle at the intersection is a right-turn route, the processor 717 may determine an expected traveling trajectory in order to change the traveling lane to a lane that is closest to the central line, among changeable lanes.

The processor 717 may change the field of view of the sensor in order to sense a lane that another vehicle can enter as the route of the vehicle after the intersection.

The processor 717 may acquire information about an object located in an expected change lane through the object detection device 300. In this case, the processor 717 may provide a signal for deceleration or acceleration. After the vehicle 100 is decelerated or accelerated, the processor 717 may provide a signal for changing the traveling lane to a lane that is closest to the central line, among changeable lanes.

The processor 717 may acquire straight section information.

The processor 717 may determine an expected traveling trajectory of the vehicle 100 based on the information about the field of view of the sensor, the straight section information, and information about a preceding vehicle detected on the straight section.

For example, the processor 717 may determine an expected traveling trajectory in order to change the traveling lane.

For example, the processor 717 may determine an expected traveling trajectory in order to change the position of the vehicle in the traveling lane.

The processor 717 may acquire information about the size of a preceding vehicle through the object detection device 300.

The processor 717 may acquire information about the distance between the vehicle 100 and the preceding vehicle through the object detection device 300.

The processor 717 may determine an expected traveling trajectory in order to change the traveling lane based on at least one of the information about the size of the preceding vehicle or the information about the distance between the vehicle 100 and the preceding vehicle.

The processor 717 may acquire information about an object located in an expected change lane through the object detection device 300. In this case, the processor 717 may provide a signal for deceleration or acceleration. After the vehicle 100 is decelerated or accelerated, the processor 717 may provide a signal for changing the traveling lane.

The power supply unit 719 may supply power necessary to operate each component under the control of the processor 717. In particular, the power supply unit 719 may receive power from a battery in the vehicle.

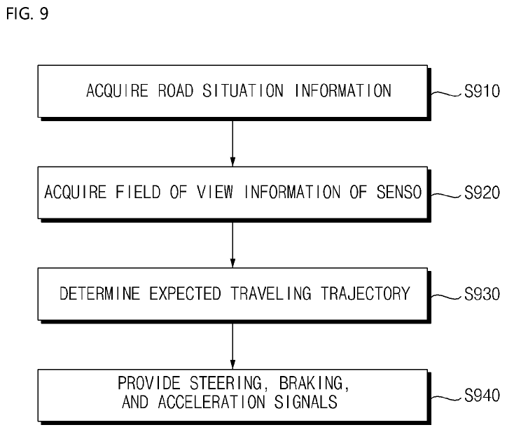

FIG. 9 is a flowchart of the traveling system according to the embodiment of the present invention.

Referring to FIG. 9, the processor 717 may acquire road situation information (S910).

The processor 717 may receive road situation information from the object detection device 300.

The processor 717 may receive road situation information from the communication device 400.

The processor 717 may receive road situation information from the navigation system 770.

For example, the processor 717 may acquire curved section information.

For example, the processor 717 may acquire intersection section information.

In some embodiments, the processor 717 may further acquire information about the route of the vehicle 100 at an intersection from the navigation system 770.

For example, the processor 717 may acquire straight section information.

In some embodiments, the processor 717 may further acquire information about a preceding vehicle on the straight section through the object detection device 300.

The processor 717 may acquire information about the field of view of the sensor (S920).

The processor 717 may acquire information about the field of view of the sensor from the object detection device 300.

The processor 717 may call information about the field of view of the sensor stored in the memory 714.

The processor 717 may determine an expected traveling trajectory of the vehicle 100 based on the information about the field of view of the sensor and road situation information (S930).

The processor 717 may determine an expected traveling trajectory of the vehicle 100 such that the vehicle 100 moves in a direction opposite the center of curvature of a curve based on the information about the field of view of the sensor and the curved section information.

The processor 717 may determine an expected traveling trajectory of the vehicle 100 based on the information about the field of view of the sensor, the intersection section information, and the information about the route of the vehicle 100 at the intersection.

The processor 717 may determine an expected traveling trajectory of the vehicle 100 based on the information about the field of view of the sensor, the straight section information, and information about a preceding vehicle detected on the straight section.

The processor 717 may provide a signal for controlling at least one of steering, braking, or acceleration based on the expected traveling trajectory (S940).

The processor 717 may provide a signal for controlling at least one of steering, braking, or acceleration to the vehicle driving device 600.

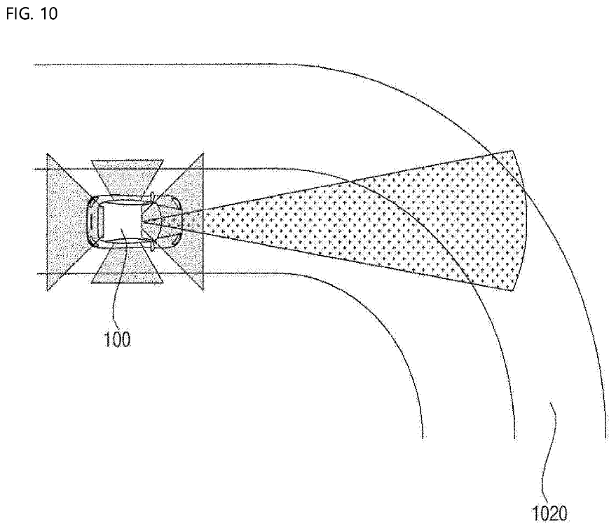

FIG. 10 is a reference view illustrating an operation of acquiring road situation information according to an embodiment of the present invention.

Referring to FIG. 10, the processor 717 may acquire situation information of a road 1020.

Specifically, the processor 717 may acquire situation information of a road 1020 on which the vehicle 100 is expected to travel.

The situation information of the road 1020 may include road shape information, road state information, and event information occurring on the road.

The road shape information may include curved section information, intersection section information, and straight section information.

The road state information may include rainy road information and snowy road information.

The event information may include accident occurrence information and construction progress information.

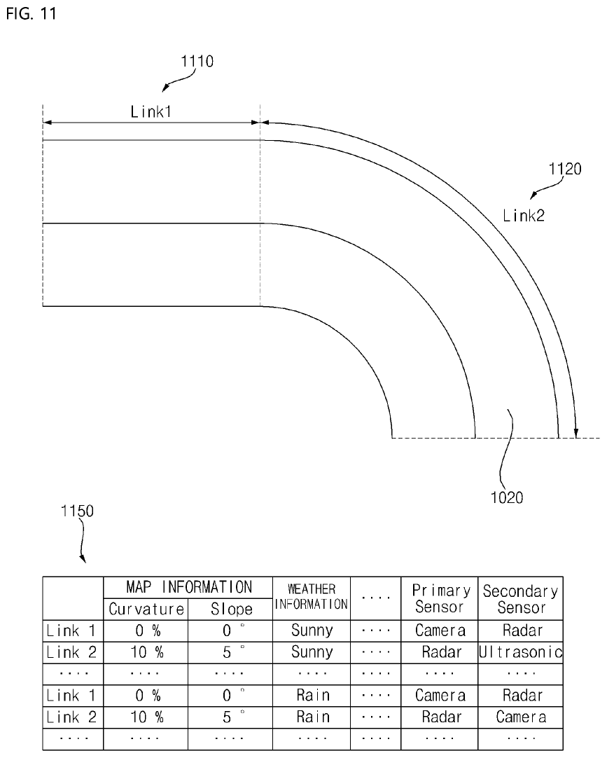

FIG. 11 is a reference view illustrating a sensor according to an embodiment of the present invention.

Referring to FIG. 11, the processor 717 may determine a main sensor from among a plurality of sensors based on the road situation information.

A plurality of vehicles may transmit sensing data sensed by a plurality of sensors in sections to a server (e.g. a traffic control server).

The server may generate a database about sensors suitable by weather and section based on the features of each sensor and cumulative data received from the vehicles.

The features of each sensor may include information about the field of view of the sensor, information about the sensing distance of the sensor, information about the sensitivity of the sensor, information about the resolution of the sensor, and information about the specifications of the sensor.

The server may store the database 1150 in the form of a table.

The processor 717 may receive the database 1150 form the server through the communication device 400.

The processor 717 may determine a main sensor from among the plurality of sensors based on the received database 1150 and the road situation information.

Meanwhile, the road situation information may include road section information.

In the case in which the vehicle 100 is expected to travel on a first section 1110, the processor 717 may determine a sensor suitable for the first section 1110 as the main sensor based on the database 1150.

In the case in which the vehicle 100 is expected to travel on a second section 1120, the processor 717 may determine a sensor suitable for the second section 1120 as the main sensor based on the database 1150.

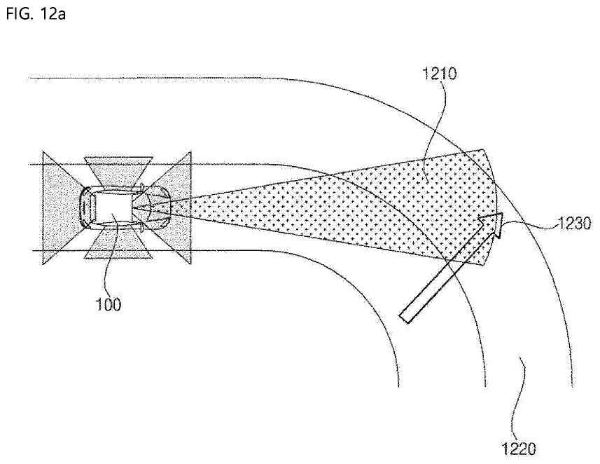

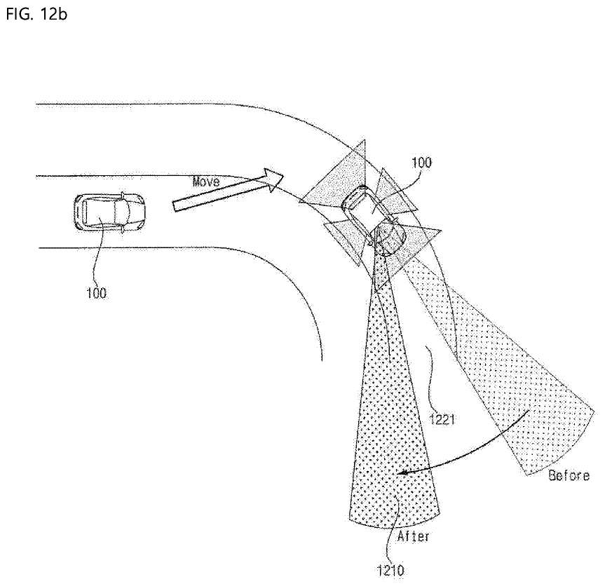

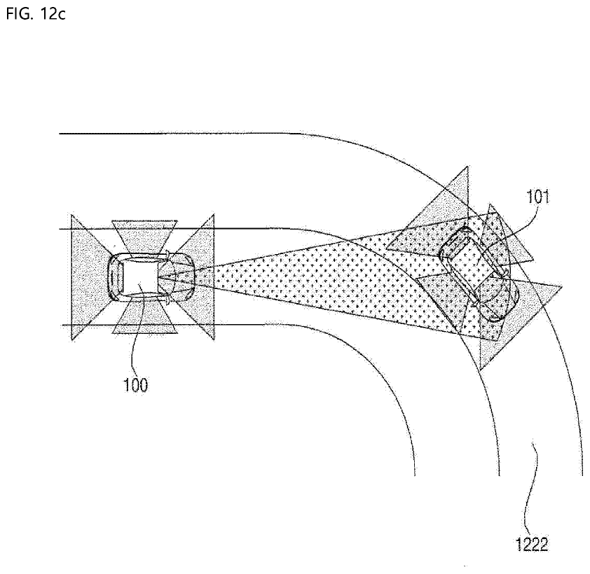

FIGS. 12a to 12c are reference views illustrating the operation of the traveling system when the vehicle travels on a curved section according to an embodiment of the present invention.

Referring to FIG. 12a, the processor 717 may acquire information about a curved section 1220.

The processor 717 may determine an expected traveling trajectory of the vehicle 100 based on the information about the field of view 1210 of the sensor and the information about the curved section 1220.

The processor 717 may determine an expected traveling trajectory based on the extent to which a sensing range depending on the field of view 1210 of the sensor is covered due to road situation.

The processor 717 may determine an expected traveling trajectory of the vehicle 100 such that the vehicle 100 moves in a direction 1230 opposite the center of curvature of a curve based on the information about the field of view 1210 of the sensor and the information about the curved section 1220.

The processor 717 may determine an expected traveling trajectory in order to change the traveling lane of the vehicle 100 in the direction 1230 opposite the center of curvature of the curve.

Meanwhile, after the traveling lane of the vehicle 100 is changed in the direction 1230 opposite the center of curvature of the curve, the processor 717 may determine an expected traveling trajectory in order to change the traveling lane of the vehicle 100 in a direction directed to the center of curvature of the curve.

Meanwhile, after the traveling lane of the vehicle 100 is changed in the direction 1230 opposite the center of curvature of the curve, the processor 717 may determine an expected traveling trajectory in order to change a heading angle of the vehicle 100 in a direction directed to the center of curvature of the curve.

The processor 717 may determine an expected traveling trajectory in order to change the position of the vehicle 100 in the traveling lane in the direction 1230 opposite the center of curvature of the curve.

Referring to FIG. 12b, the processor 717 may provide a signal for controlling at least one of steering, braking, or acceleration based on the expected traveling trajectory.

The traveling lane of the vehicle 100 may be changed in the direction opposite the center of curvature of the curve based on the signal provided by the processor 717.

The position of the vehicle 100 in the traveling lane may be changed in the direction opposite the center of curvature of the curve based on the signal provided by the processor 717.

The position of the vehicle 100 may be changed so as to be closer to one of two lines in the traveling lane based on the signal provided by the processor 717.

The processor 717 may change the field of view of the sensor.

For example, the processor 717 may change the field of view 1210 of the sensor so as to be directed to an expected traveling lane 1221.

Referring to FIG. 12c, the processor 717 may acquire information about another vehicle 101 located in an expected change lane 1222 through the object detection device 300.

The processor 717 may provide a signal for deceleration or acceleration.

After the vehicle 100 is decelerated or accelerated, the processor 717 may provide a signal for changing the traveling lane in the direction opposite the center of curvature of the curve.

The traveling lane of the vehicle 100 may be changed behind or ahead of the vehicle 101.

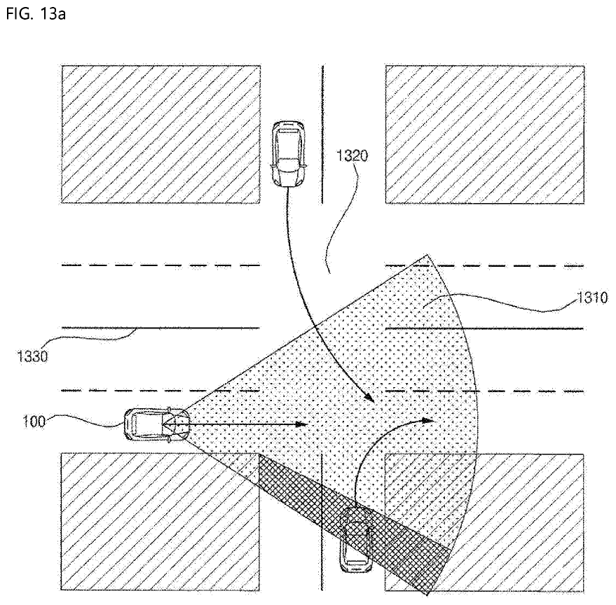

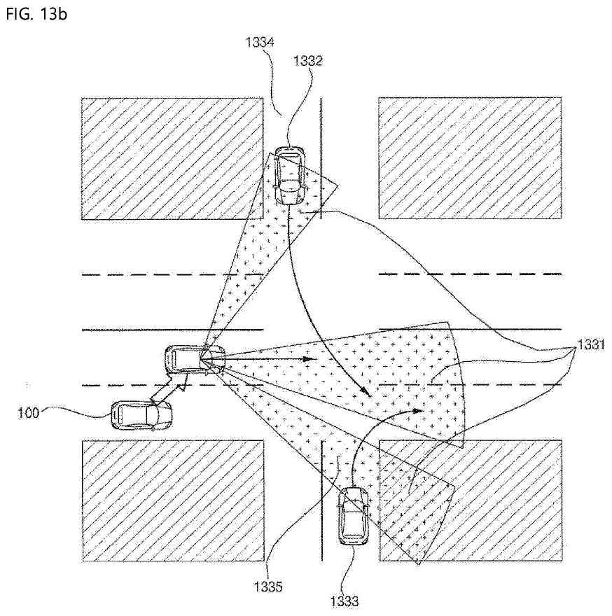

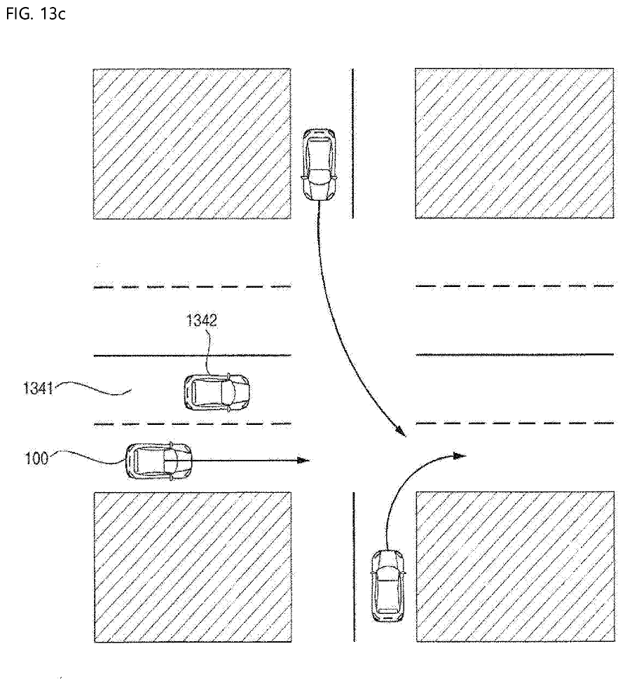

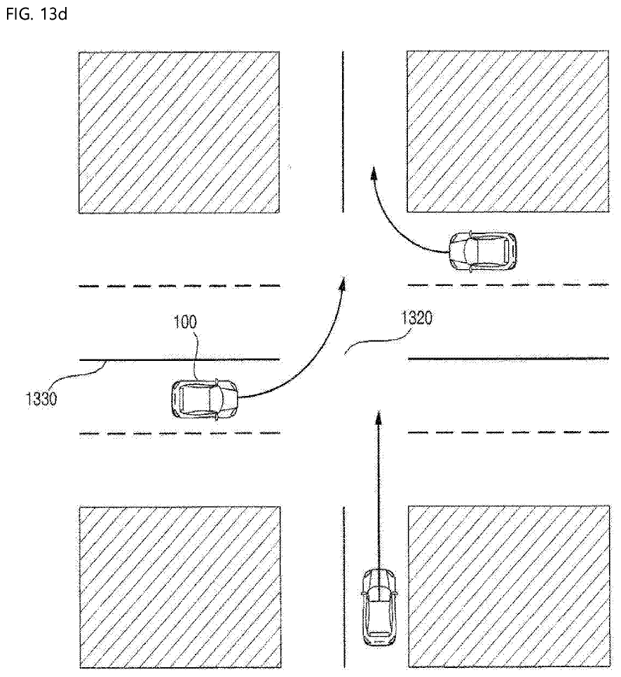

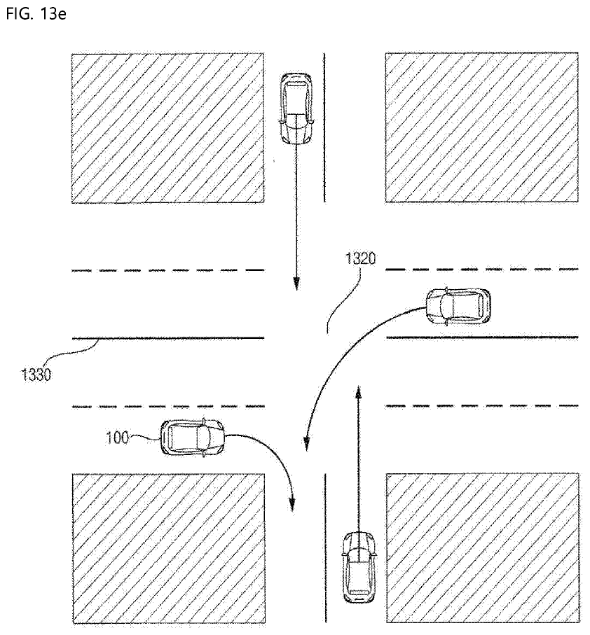

FIGS. 13a to 13e are reference views illustrating the operation of the traveling system when the vehicle travels on an intersection section according to an embodiment of the present invention.

FIGS. 13a to 13e exemplarily show the case in which the vehicle moves straight at an intersection.

Referring to FIG. 13a, the processor 717 may acquire intersection section information.

The processor 717 may determine an expected traveling trajectory of the vehicle 100 based on information about the field of view 1310 of the sensor, information about an intersection section 1320, and information about the route of the vehicle 100 at the intersection.

The processor 717 may determine an expected traveling trajectory based on the extent to which a sensing range depending on the field of view of the sensor is covered due to road situation.

The processor 717 may determine an expected traveling trajectory based on the extent to which the field of view of the sensor deviates from a road due to road situation.

In the case in which the route of the vehicle 100 at the intersection section 1320 is a straight route, the processor 717 may determine an expected traveling trajectory in order to change the traveling lane to a lane that is closest to a central line 1330, among changeable lanes.

Upon determining that no object is present within a predetermined distance in front and rear of a lane next to the traveling lane, the processor 717 may determine the next lane to be a changeable lane. Here, the next lane may be a lane in which the vehicle is movable straight.

Upon determining that there is no changeable lane, the processor 717 may determine an expected traveling lane in order to change the position of the vehicle 100 in the traveling lane based on the field of view information and the road situation information.

Referring to FIG. 13b, the processor 717 may provide a signal for controlling at least one of steering, braking, or acceleration based on the expected traveling trajectory.

The traveling lane of the vehicle 100 may be changed to a lane that is closest to the central line, among changeable lanes, based on the signal provided by the processor 717.

The position of the vehicle 100 in the traveling lane may be changed so as to be adjacent to the center line based on the signal provided by the processor 717.

The position of the vehicle 100 may be changed so as to be closer to one of two lines in the traveling lane based on the signal provided by the processor 717.

The processor 717 may change the field of view of the sensor.

For example, the processor 717 may change the field of view 1331 of the sensor in order to sense lanes 1334 and 1335 that other vehicles 1332 and 1333 can enter as routes 1331 of the vehicle after the intersection.

Referring to FIG. 13c, the processor 717 may acquire information about another vehicle 1342 located in an expected change lane 1341 through the object detection device 300.

The processor 717 may provide a signal for deceleration or acceleration.

After the vehicle 100 is decelerated or accelerated, the processor 717 may provide a signal for changing the traveling lane to a lane that is closest to the central line, among changeable lanes.

The traveling lane of the vehicle 100 may be changed behind or ahead of the vehicle 1342.

FIG. 13d exemplarily shows the case in which the vehicle turns left at an intersection.

Referring to FIG. 13d, in the case in which the route of the vehicle 100 at the intersection 1320 is a left-turn route, the processor 717 may determine an expected traveling trajectory in order to change the traveling lane to a lane that is closest to the central line 1330, among changeable lanes.

Upon determining that no object is present within a predetermined distance in front and rear of a lane next to the traveling lane, the processor 717 may determine the next lane to be a changeable lane. Here, the next lane may be a lane in which the vehicle is capable of turning left.

Upon determining that there is no changeable lane, the processor 717 may determine an expected traveling lane in order to change the position of the vehicle 100 in the traveling lane based on the field of view information and the road situation information.

The processor 717 may provide a signal for controlling at least one of steering, braking, or acceleration based on the expected traveling trajectory.

The traveling lane of the vehicle 100 may be changed to a lane that is closest to the central line, among changeable lanes, based on the signal provided by the processor 717.

The position of the vehicle 100 in the traveling lane may be changed so as to be adjacent to the center line based on the signal provided by the processor 717.

The position of the vehicle 100 may be changed so as to be closer to one of two lines in the traveling lane based on the signal provided by the processor 717.

The processor 717 may change the field of view of the sensor.

For example, the processor 717 may change the field of view of the sensor in order to sense a lane that another vehicle can enter as the route of the vehicle after the intersection.

The processor 717 may acquire information about an object located in an expected change lane through the object detection device 300.

The processor 717 may provide a signal for deceleration or acceleration.

After the vehicle 100 is decelerated or accelerated, the processor 717 may provide a signal for changing the traveling lane to a lane that is closest to the central line, among changeable lanes.

The traveling lane of the vehicle 100 may be changed behind or ahead of the other vehicle.

FIG. 13e exemplarily shows the case in which the vehicle turns right at an intersection.

Referring to FIG. 13e, in the case in which the route of the vehicle 100 at the intersection 1320 is a right-turn route, the processor 717 may determine an expected traveling trajectory in order to change the traveling lane to a lane that is closest to the central line 1330, among changeable lanes.

Upon determining that no object is present within a predetermined distance in front and rear of a lane next to the traveling lane, the processor 717 may determine the next lane to be a changeable lane. Here, the next lane may be a lane in which the vehicle is capable of turning right.

Upon determining that there is no changeable lane, the processor 717 may determine an expected traveling lane in order to change the position of the vehicle 100 in the traveling lane based on the field of view information and the road situation information.

The processor 717 may provide a signal for controlling at least one of steering, braking, or acceleration based on the expected traveling trajectory.

The traveling lane of the vehicle 100 may be changed to a lane that is closest to the central line, among changeable lanes, based on the signal provided by the processor 717.

The position of the vehicle 100 in the traveling lane may be changed so as to be adjacent to the center line based on the signal provided by the processor 717.

The position of the vehicle 100 may be changed so as to be closer to one of two lines in the traveling lane based on the signal provided by the processor 717.

The processor 717 may change the field of view of the sensor.

For example, the processor 717 may change the field of view of the sensor in order to sense a lane that another vehicle can enter as the route of the vehicle after the intersection.

The processor 717 may acquire information about an object located in an expected change lane through the object detection device 300.

The processor 717 may provide a signal for deceleration or acceleration.

After the vehicle 100 is decelerated or accelerated, the processor 717 may provide a signal for changing the traveling lane to a lane that is closest to the central line, among changeable lanes.

The traveling lane of the vehicle 100 may be changed behind or ahead of the other vehicle.

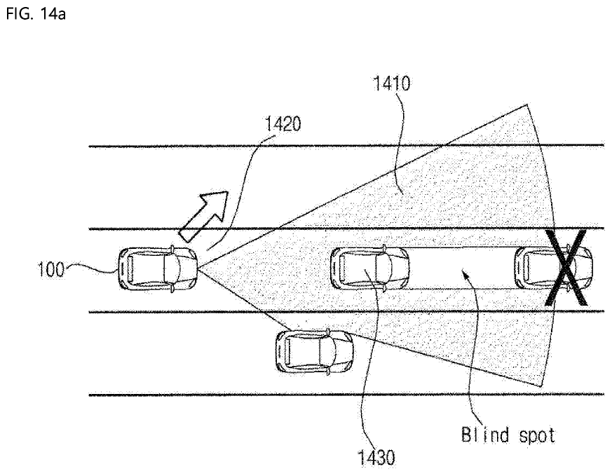

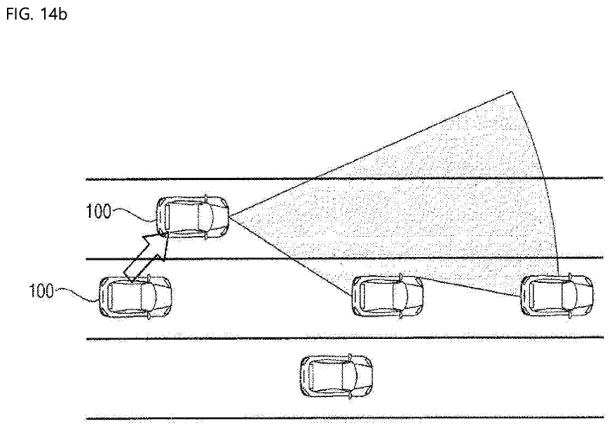

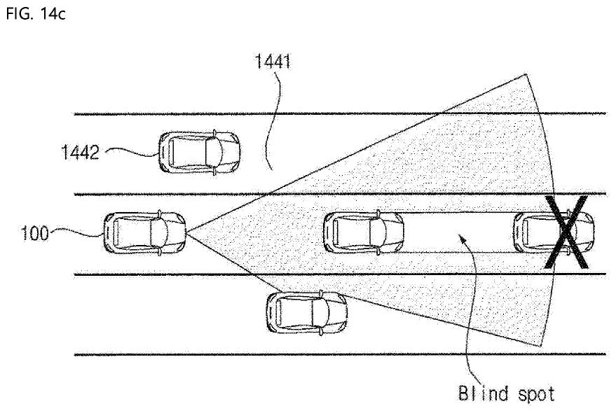

FIGS. 14a to 14c are reference views illustrating the operation of the traveling system when the vehicle travels on a straight section according to an embodiment of the present invention.

Referring to FIG. 14a, the processor 717 may acquire straight section information.

The processor 717 may determine an expected traveling trajectory of the vehicle 100 based on information about the field of view 1410 of the sensor, information about an intersection section 1420, and information about a preceding vehicle 1430 detected on the straight section.

The processor 717 may determine an expected traveling trajectory based on the extent to which a sensing range depending on the field of view of the sensor is covered due to road situation 1420 and the vehicle 1430.

The processor 717 may acquire information about the size of the preceding vehicle 1430 through the object detection device 300.

The processor 717 may acquire information about the distance between the vehicle 100 and the preceding vehicle 1430 through the object detection device 300.

The processor 717 may also determine an expected traveling trajectory in order to change the traveling lane based on at least one of the information about the size of the preceding vehicle or the information about the distance between the vehicle 100 and the preceding vehicle.

The processor 717 may also determine an expected traveling trajectory in order to change the position of the vehicle 100 in the traveling lane based on at least one of the information about the size of the preceding vehicle or the information about the distance between the vehicle 100 and the preceding vehicle.

Referring to FIG. 14b, the processor 717 may provide a signal for controlling at least one of steering, braking, or acceleration based on the expected traveling trajectory.

The traveling lane of the vehicle 100 may be changed to a lane next thereto based on the signal provided by the processor 717.

The position of the vehicle 100 may be changed so as to be closer to one of two lines in the traveling lane based on the signal provided by the processor 717.

Referring to FIG. 14c, the processor 717 may acquire information about another vehicle 1442 located in an expected change lane 1441 through the object detection device 300.

The processor 717 may provide a signal for deceleration or acceleration.

After the vehicle 100 is decelerated or accelerated, the processor 717 may provide a signal for changing the traveling lane to a lane that is closest to the central line, among changeable lanes.

The traveling lane of the vehicle 100 may be changed behind or ahead of the vehicle 1442.

The present invention as described above may be implemented as code that can be written on a computer-readable medium in which a program is recorded and thus read by a computer. The computer-readable medium includes all kinds of recording devices in which data is stored in a computer-readable manner. Examples of the computer-readable recording medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disc, and an optical data storage device. In addition, the computer-readable medium may be implemented as a carrier wave (e.g. data transmission over the Internet). In addition, the computer may include a processor or a controller. Thus, the above detailed description should not be construed as being limited to the embodiments set forth herein in all terms, but should be considered by way of example. The scope of the present invention should be determined by the reasonable interpretation of the accompanying claims and all changes in the equivalent range of the present invention are intended to be included in the scope of the present invention.

1. A traveling system comprising:
an object detection device comprising at least one sensor; and
a processor configured to:
acquire road situation information;
determine an expected traveling trajectory of a vehicle based on information about a field of view of the sensor and the road situation information; and
provide a signal for controlling at least one of steering, braking, or acceleration based on the expected traveling trajectory.

2. The traveling system according to claim 1, wherein
the object detection device comprises a camera sensor, a radar sensor, a lidar sensor, an ultrasonic sensor, and an infrared sensor, and
the processor is configured to determine at least one of the camera sensor, the radar sensor, the lidar sensor, the ultrasonic sensor, or the infrared sensor as a main sensor based on road situation information.

3. The traveling system according to claim 2, wherein the processor is configured to determine an expected traveling trajectory of the vehicle 100 based on information about a field of view of a sensor determined as the main sensor and the road situation information.

4. The traveling system according to claim 3, wherein the processor is configured to change the field of view of the sensor determined as the main sensor.

5. The traveling system according to claim 1, wherein the processor is configured to determine the expected traveling trajectory of the vehicle based on an extent to which a sensing range depending on the field of view of the sensor is covered due to the road situation or an extent to which the field of view of the sensor deviates from a road due to the road situation.

6. The traveling system according to claim 1, wherein the processor is configured to determine the expected traveling trajectory in order to change a traveling lane of the vehicle based on the field of view information and the road situation information.

7. The traveling system according to claim 1, wherein the processor is configured to determine the expected traveling trajectory in order to change a position of the vehicle in a traveling lane based on the field of view information and the road situation information.

8. The traveling system according to claim 1, wherein the processor is configured to:
acquire curved section information; and
determine the expected traveling trajectory of the vehicle such that the vehicle moves in a direction opposite a center of curvature of a curve based on the field of view information and the curved section information.

9. The traveling system according to claim 8, wherein the processor is configured to determine the expected traveling trajectory in order to change a traveling lane of the vehicle in the direction opposite the center of curvature of the curve.

10. The traveling system according to claim 9, wherein the processor is configured to determine the expected traveling trajectory in order to change the traveling lane of the vehicle in a direction directed to the center of curvature of the curve after the traveling lane of the vehicle is changed in the direction opposite the center of curvature of the curve.

11. The traveling system according to claim 9, wherein the processor is configured to provide a signal for deceleration or acceleration in a case in which the processor acquires information about an object located in an expected change lane through the object detection device.

12. The traveling system according to claim 1, wherein the processor is configured to:
acquire intersection section information; and
determine the expected traveling trajectory of the vehicle based on the field of view information, the intersection section information, and information about a route of the vehicle at the intersection.

13. The traveling system according to claim 12, wherein the processor is configured to determine the expected traveling trajectory in order to change a traveling lane to a lane that is closest to a central line, among changeable lanes, in a case in which the route of the vehicle at the intersection is a straight route or a left-turn route.

14. The traveling system according to claim 13, wherein the processor is configured to change the field of view of the sensor in order to sense a lane that another vehicle can enter as the route of the vehicle after the intersection.

15. The traveling system according to claim 13, wherein the processor is configured to provide a signal for deceleration or acceleration in a case in which the processor acquires information about an object located in an expected change lane through the object detection device.

16. The traveling system according to claim 12, wherein the processor is configured to determine the expected traveling trajectory in order to change a traveling lane to a lane that is closest to a central line, among changeable lanes, in a case in which the route of the vehicle at the intersection is a right-turn route.

17. The traveling system according to claim 1, wherein the processor is configured to:
acquire straight section information; and
determine the expected traveling trajectory of the vehicle based on the field of view information, the straight section information, and information about a preceding vehicle detected on the straight section.

18. The traveling system according to claim 17, wherein the processor is configured to determine the expected traveling trajectory in order to change a traveling lane based on at least one of:
information about a size of the preceding vehicle; or
information about a distance between the vehicle and the preceding vehicle.

19. The traveling system according to claim 17, wherein the processor is configured to provide a signal for deceleration or acceleration in a case in which the processor acquires information about an object located in an expected change lane through the object detection device.

20. A vehicle comprising:
the traveling system according to claim 1; and
a plurality of wheels configured to be driven based on a control signal generated by the traveling system.
